(19) United States
(12) Patent Application Publication
(10) Pub. No.: US 2009/0045305 A1
(43) Pub. Date: Feb. 19, 2009

(54) TILT DEVICE AND ELECTRONIC EQUIPMENT

(75) Inventors: Kenji OSHIMA, Shiojiri-shi (JP); Kazuyoshi IWAMA, Matsumoto-shi (JP); Mami HASHIZUME, Ina-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/176,740

(22) Filed: Jul. 21, 2008

(30) Foreign Application Priority Data
Jul. 20, 2007 (JP) 2007-190041
Jul. 15, 2008 (JP) 2008-183663

(51) Int. Cl. A47B 96/06; G02F 1/1333

(52) U.S. Cl. 248/205.1; 349/60

(57) ABSTRACT

[Object] To provide a tilt device which has less possibility of deterioration of a load applying portion with time and has durability for a long time use.

[Solving Means] There are provided a tilting member 10 being capable of tilting with respect to a hinged end 11 and assuming a first posture and a second posture; a supporting members 4, 9 that support the tilting member 10 in a tiltable state; a load applying portion 20 provided between the tilting member 10 and the supporting members 4, 9 for applying a tilting load in a state in which the tilting member is positioned between the first posture and the second posture, and not applying the tilting load to the tilting member 10 when the tilting member 10 is positioned at least one of the first posture position and the second posture position.

### TECHNICAL FIELD

The present invention relates to a tilt device including a tilting member which tilts with respect to a hinged end and assumes a first posture and a second posture, and also a posture between the first posture and the second posture, and a supporting member which supports the tilting member in a tiltable state, and an electronic apparatus such as a printing apparatus which applies the tilt device between a liquid crystal display and a body housing.

### BACKGROUND ART

Many electronic apparatuses such as compact-sized registers, calculators, car navigations, telephone sets, printers, facsimiles, digital video cameras include a tilt device which allows the angle of a liquid crystal display to be changed freely. The tilt device in the related art is provided with a load applying portion including a frictional member or an urging member which is constantly in a load-applying state irrespective of the posture position of the liquid crystal display between the liquid crystal display as a tilting member and a body housing as a liquid crystal display supporting member as shown in JP-A-2003-110248 and JP-A-2003-148450.

However, such the load applying portion is subjected to deterioration with time such as deformation due to creep since it is constantly in the load-applying state, and there is a possibility that provision of required magnitude of load is disabled in a short time.

In the case of the tilt device in the related art in which the load applying portion which is constantly in the load-applying state is applied, there is a problem such that whether the liquid crystal display is completely in a normal folded posture or an upright posture is difficult to determine.

[Patent Document 1] JP-A-2003-110248

[Patent Document 2] JP-A-2003-148450

### DISCLOSURE OF THE PRESENT INVENTION

### Problems to be Solved by the Present Invention

In view of the presence of the problems in the related art as described above, it is an object of the present invention to provide a tilt device which has less possibility of deterioration of a load applying portion with time and has durability for a long time use, and an electronic apparatus in which the tilt device is applied between a liquid crystal display and a body housing.

### Means for Solving the Problems

I order to achieve the object as described above, a tilt device according to a first aspect of the present invention includes: a tilting member being capable of tilting with respect to a hinged end and tilting and being displaced between a first posture and a second posture; a supporting member that supports the tilting member in a tiltable state; a load applying portion provided between the tilting member and the supporting member for applying a tilting load which allows the tilting member to tilt in a state in which the tilting member is positioned between the first posture and the second posture and allows the tilting member to standstill at a desired posture position in a state of being free from a tilting force, at least one of the first posture position and the second posture position being out of a range where the tilting load from the load applying portion does not reach; and a posture retaining portion that retains the posture of the tilting member positioned out of the range that the load applying portion applies the tilting load.

According to this aspect, when the tilting member is positioned between the first posture and the second posture, the titling load acts from the load applying portion to the tilting member. Therefore, the tilting member is able to be fixed at a desired position by changing its posture, for example, steplessly owing to the tilting load. In contrast, when the tilting member is at least at one of the first posture position and the second posture position, the tilting load is not applied to the tilting member. Therefore, the possibility of the deterioration with time, which is a problem of a case where the tilting load is constantly applied as in the related art, is reduced. In other words, continuous and stable application of the required magnitude of tilting load to the tilting member is enabled.

In the tilt device according to a second aspect described above, a second aspect of the present invention is characterized in that the load applying portion includes a resilient strip provided on the supporting member; a press-contact receiving portion provided at a proximal end of a tilting movement of the tilting member; a press-contact applying portion provided on part of the resilient strip, assuming a press-contact state with the press-contact receiving portion of the tilting member in a state in which the tilting member is positioned between the first posture and the second posture and assuming a non-press-contact state with respect to the press-contact receiving portion when the tilting member is positioned at least at one of the first posture position and the second posture position.

According to this aspect, the following advantages and effects are achieved in addition to the effects and advantages according to the first aspect. The load applying portion includes the resilient strip provided on the side of the supporting member, the press-contact receiving portion provided at the proximal end of the tilting member, and the press-contact applying portion provided on part of the resilient strip. Therefore, changeover of the tilting load between application and non-application is realized in a simple structure with less number of components at low cost.

In a tilt device according to the second aspect described above, a third aspect of the present invention is characterized in that the resilient strip is provided with a storage section at the other portion for storing the press-contact receiving portion of the tilting member in a state of being free from the tilting load when the tilting member is at the first posture position or the second posture position.

According to this aspect, the following advantages and effects are achieved in addition to the advantages and effects in the second aspect. The storage section is provided on the other portion of the resilient strip for storing the press-contact receiving portion of the tilting member in the storage section in the state of being free from the tilting load when the tilting member is at the first posture position or the second posture position. Therefore, the posture position of the tilting member is stably maintained.

In particular, when the press-contact receiving portion of the tilting member is released from the state of being stored in the storage section, transition to the contact state with respect to the press-contact applying portion is achieved, so that the efficient structure is achieved, and downsizing is easily realized without generating a dead space.

In the tilt device according to the second or third aspect described above, a fourth aspect of the present invention is characterized in that the press-contact applying portion is provided at a free end of the resilient strip at a portion protruded toward the tilting member, and the press-contact applying portion is adapted to be displaced to the maximum when a front end of the press-contact receiving portion of the tilting member in the direction of the tilting movement comes into contact with the press-contact applying portion and when a rear end of the press-contact receiving portion of the tilting member in the direction of the tilting movement comes into contact with the press-contact applying portion.

According to this aspect, the following advantages and effects are achieved in addition to the advantages and effects in the second aspect or the third aspect. When the tilting member at the first posture position or the second posture position is started to move therefrom, and when the tilting member reaches the first posture position or the second posture position, the press-contact applying portion is displaced to the maximum, and hence tactile feedback is provided. Therefore, an operator is able to know the current posture of the tilting member sensuously and hence the operability of the tilt device is improved and a good operative feeling is obtained.

In the tilt device according to any one of the second aspect to the fourth aspect, a fifth aspect of the present invention is characterized in that the tilting member has a tendency to tilt toward the first posture position by the tilting member's own weight when being at the second posture position, and the posture retaining portion is provided at the free end of the resilient strip and includes a seat portion for allowing an end portion of the press-contact receiving portion of the tilting member to be seated thereon and supporting the tilting member's own weight.

According to this aspect, the following advantages and effects are achieved in addition to the advantages and effects in any one of the second aspect to the fourth aspect. The tilting member is not applied with the tilting load when being at the second posture position. However, the end portion of the press-contact receiving portion of the tilting member is seated and comes into contact with the seat portion provided on the resilient strip. Therefore, the tilting member is kept at the second posture position in a simple structure.

In the tilt device according to any one of the second aspect to the fifth aspect described above, the sixth aspect of the present invention is characterized in that the press-contact receiving portion of the tilting member is formed into an arcuate curved surface having a constant radius about a hinged end, and the length in the circumferential direction of the arcuate curved surface is set to a length which prevents the tilting member from receiving the tilting load from the resilient strip in the state in which the tilting member is positioned at the first posture position or the second posture position.

According to this aspect, the following advantages and effects are achieved in addition to the advantages and effects in any one of the second aspect to the fifth aspect. The press-contact receiving portion of the tilting member is formed into the arcuate curved surface having the constant radius about the hinged end. Therefore, when the tilting member is at an intermediate position between the first posture position and the second posture position, and a constant tilting load is always applied to the press-contact receiving portion of the tilting member, therefore, the stability and operability are improved.

In the tilt device according to any one of the first to the sixth aspects, a seventh aspect of the preset invention is characterized in that the resilient strip is a tongue-shaped member which is resiliently flexible and deformable and is formed integrally with the supporting member extending from a portion of the supporting member positioned on the side of the proximal end of the tilting movement of the tilting member.

According to this aspect, the following advantages and effects are achieved in addition to the advantages and effects in any one of the first aspect to the sixth aspect. The resilient strip is the tongue-shaped member which is resiliently flexible and deformable and is formed integrally with the supporting member extending from the portion of the supporting member positioned on the side of the proximal end of the tilting movement of the tilting member. Therefore, the proximal end of the tilting movement of the tilting member is covered with the resilient strip, and hence entry and attachment of the dust or the like to the hinged end are prevented, so that a smooth tilting movement of the tilting member is secured. In addition, the resilient member is configured with a simple structure without increasing the number of components, which contributes to downsizing of the tilt device and reduction of the product cost.

In the tilt device according to any one of the first to seventh aspects, an eighth aspect of the present invention is characterized in that the supporting member includes the resilient strip and an auxiliary resilient strip for supporting the resilient strip from below for reinforcing the resilient force of the resilient strip.

According to this aspect, the following advantages and effects are achieved in addition to the advantages and effects in any one of the first to seventh aspects. The supporting member includes the resilient strip and the auxiliary resilient strip for supporting the resilient strip from below for reinforcing the resilient force of the resilient strip. Therefore, even when the resilient force of the resilient strip cannot be increased structurally, the resilient force of the resilient strip is substantially increased by the auxiliary resilient strip, so that a desired titling load is obtained. The tilt device which is able to accommodate a large-sized tilting member is provided without upsizing the resilient strip.

An electronic apparatus according to a ninth aspect of the present invention includes a liquid crystal display for displaying various kinds of information; a body housing for mounting the liquid crystal display; and a tilt device applied between the liquid crystal display and the body housing for causing the liquid crystal display to tilt with respect to a hinged end to a first posture and a second posture and also to a posture between the first posture and the second posture, in which the tilt device includes: a load applying portion for providing a tilting load which allows the liquid crystal display to tilt in a state in which the liquid crystal display is positioned between the first posture and the second posture and allows the liquid crystal display to standstill at a desired posture position in a state of being free from a tilting force, at least one of the first posture position and the second posture position being out of a range where the tilting load from the load applying portion does not reach; and a posture retaining portion that retains the posture of the liquid crystal display positioned out of the range that the load providing portion applies the tilting load. According to this aspect, the same advantages and effects as described above are achieved in the electronic apparatus such as a printer having the tilt device.

In the electronic apparatus according to the ninth aspect described above, a tenth aspect of the present invention is characterized in that the press-contact applying portion is provided at a free end of the liquid crystal display at a portion protruded toward the liquid crystal display, and the press-contact applying portion is adapted to be displaced to the maximum when a front end of the press-contact receiving portion of the liquid crystal display in the direction of the tilting movement comes into contact with the press-contact applying portion and when a rear end of the press-contact receiving portion of the liquid crystal display in the direction of the tilting movement comes into contact with the press-contact applying portion.

According to this aspect, when the liquid crystal display at the first posture position or the second posture position is started to move therefrom, and when the liquid crystal display reaches the first posture position or the second posture position, the press-contact applying portion is displaced to the maximum, and hence tactile feedback is provided. Therefore, the operator is able to know the current posture of the liquid crystal display sensuously and hence the operability is improved and a good operative feeling is obtained.

### BRIEF DESCRIPTION OF THE DRAWINGS

FIG. 1 is a perspective view showing an appearance of an ink jet printer according to the present invention.

FIG. 2 is a perspective view of the printer having a tilt device according to a first embodiment in a state in which an upper cover is removed;

FIG. 3 is an exploded perspective view of a portion around a mounting portion of an operation panel and a liquid crystal display of the same printer in an enlarged scale.

FIG. 4 is a perspective view of the liquid crystal display of the same printer in an enlarged scale.

FIG. 5 is an exploded perspective view of the liquid crystal display of the same printer.

FIG. 6 is a perspective view of the same printer in a state in which a body housing is inverted.

FIG. 7 is a perspective view of the portion around the mounting portion of the operation panel and the liquid crystal display of the same printer in an enlarged scale.

FIG. 8 is a perspective view showing a portion around a tilt device of the same printer viewed from the back side in an enlarged scale.

FIG. 9 is a side cross section showing an operating state of the tilt device when the liquid crystal display of the same printer is in a folded posture position.

FIG. 10 is a side cross section showing an operating state of the tilt device when the liquid crystal display of the same printer is in a position between the folded posture position and an upright posture position.

FIG. 11 is a side cross section showing an operating state of the tilt device when the liquid crystal display of the same printer is in the upright posture position.

FIG. 12 is a side cross section showing an operating state of the tilt device when a liquid crystal display in a second embodiment is in a folded posture position.

FIG. 13 is a side cross section showing an operating state of the tilt device when a liquid crystal display in a third embodiment is in a folded posture position.

### REFERENCE NUMERALS

1 tilt device, 3 printer body (printing apparatus body), 4 body housing (supporting member), 5 paper feed tray, 6 paper support, 7 upper cover, 8a, 8b, 8c, . . . 8n operating switch, 9 operation panel (supporting member), 10 liquid crystal display (tilting member), 11 hinged end, 12 bearings, 15 edge guide, 20 load applying portion, 21 cover, 22 upper housing, 23 lower housing, 24 window portion, 25 locking claw, 26 locked portion, 27 shaft portion, 28 arm portion, 29 press-contact receiving portion, 30 resilient strip, 31 press-contact applying portion, 32 upper cover mounting portion, 33 paper support mounting portion, 34 operation panel mounting portion, 35 locking claw, 36 locking boss, 37 auxiliary resilient strip, 38 resiliency providing portion, 39 storage section, 40 front end, 41 rear end, 42 projecting portion, 43 mounting screw, 44 rotatable support providing portion, 45 another resilient strip, 46 seat portion, 100 ink jet printer (printing apparatus), P sheet (printed material), R radius, L length in the circumferential direction, F tilting load, 0 tilting angle

### BEST MODE FOR CARRYING OUT THE INVENTION

A printing apparatus as an example of an electronic apparatus in which a tilt device according to an aspect of the present invention and an electronic apparatus in which the tilt device is applied between a liquid crystal display and a body housing will be described below. First of all, an ink jet printer 100 is exemplified as a best mode of a printing apparatus for carrying out the present invention and the entire configuration thereof will be described schematically on the basis of the drawings.

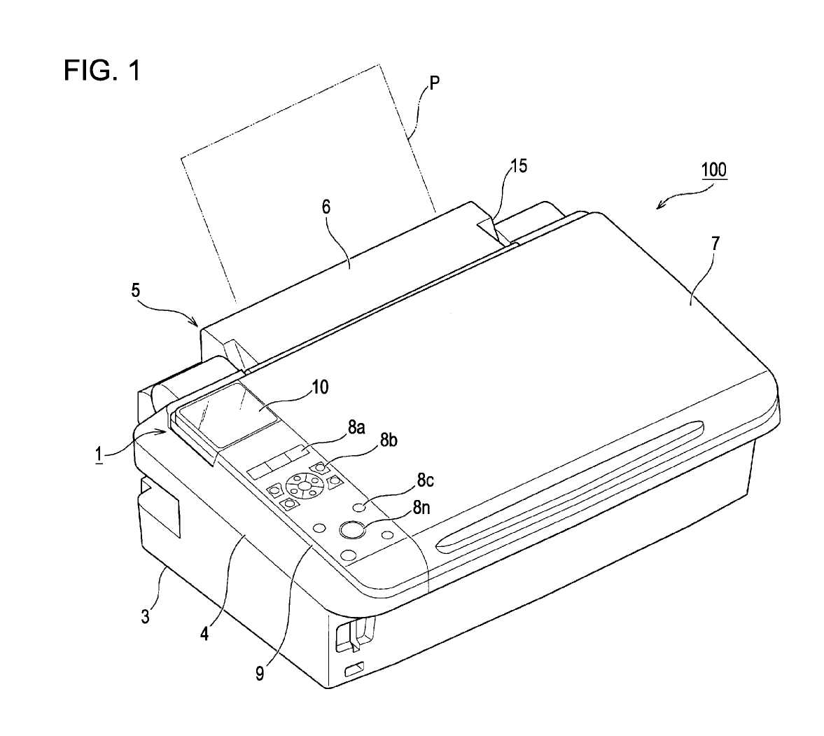

FIG. 1 is a perspective view showing an appearance of the ink jet printer viewed obliquely from the front left. The ink jet printer 100 described here is a middle-sized multipurpose ink jet printer for a printed material (also referred to as “sheet” in this specification) P of, for example, A4 size or smaller. However, the present invention is not limited to this type as a matter of course. The ink jet printer 100 includes a printer body 3 as an example of a printing apparatus body, and includes a body housing 4 above the printer body 3. A paper support 6 of a holding type that supports the back surface of the lowermost sheet P stacked on a paper feed tray 5 is provided above the body housing 4 at a position to the rear. The sheets P stacked on the paper feed tray 5 is automatically and consecutively fed one by one by being pinched and advanced by a feeding roller and a hopper, not shown, while being guided at left and right edges thereof by an edge guide 15.

tiltable upper cover 7 which is opened and closed in the vertical direction is provided on the upper surface of the body housing 4. As an example of the upper cover 7, there are provided an operation panel 9 having various operation switches 8a, 8b, . . . , 8n arranged on the left side when viewed from the front and a liquid crystal display 10 for displaying various information such as paper size, paper type, number of sheets to be printed, and so on, on the basis of the operation using the operation switches 8a, 8b, . . . , 8n. A tilt device 1 according to an aspect of the present invention, described later, is provided between the liquid crystal display 10 and the body housing 4. The liquid crystal display 10 is adapted to be tilted about a hinged end 11 by the operation of the tilt device 1 so as to switch the posture between a folded posture as a first posture and an upright posture as a second posture, and to be fixed in different posture steplessly between the folded posture and the upright posture.

The automatically fed sheet P is fed to transportation rollers, not shown, including a pair of nip rollers, that is, a transportation drive roller and a transportation driven roller, and is guided to a printing position by a transportation force of the transportation rollers. A printhead, not shown, as a printing unit and a platen, not shown, for supporting the lower surface of the sheet P and defining a gap with respect to the printhead are provided at the printing position. The sheets P after having printed are discharged on a placing surface of a discharging stacker, not shown, provided at a downstream end in the direction of transportation of the sheet by discharge rollers, not shown, including a pair of nip rollers, that is, a discharge drive roller and a discharge driven roller, and are stuck on the placing surface of the discharge stacker.

### FIRST EMBODIMENT

Referring now to the drawings, the tilt device 1 according to a first embodiment of the present invention applied between the liquid crystal display 10 and the body housing 4 of the ink jet printer 100 configured as described above will be described as an example in detail.

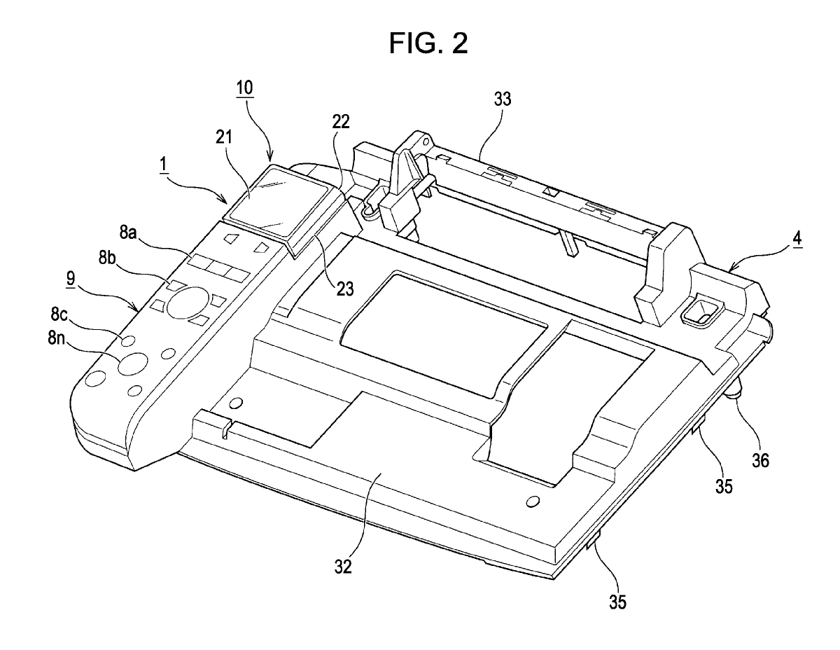

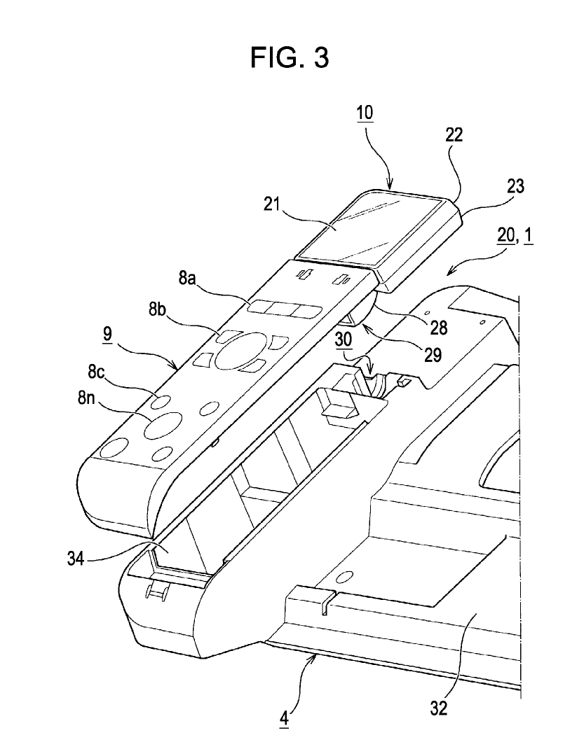

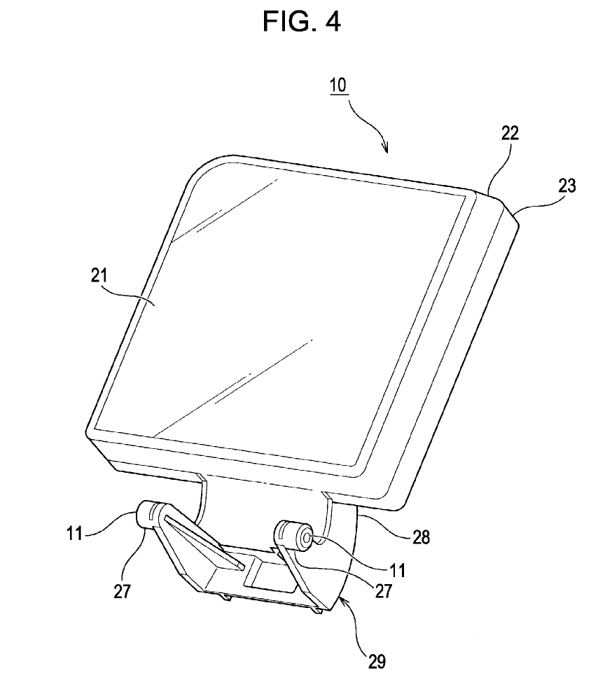

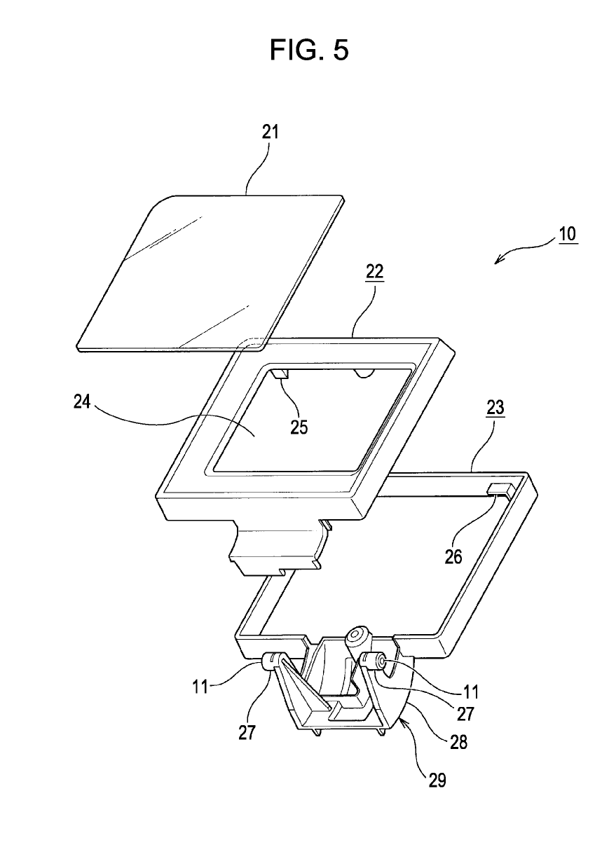

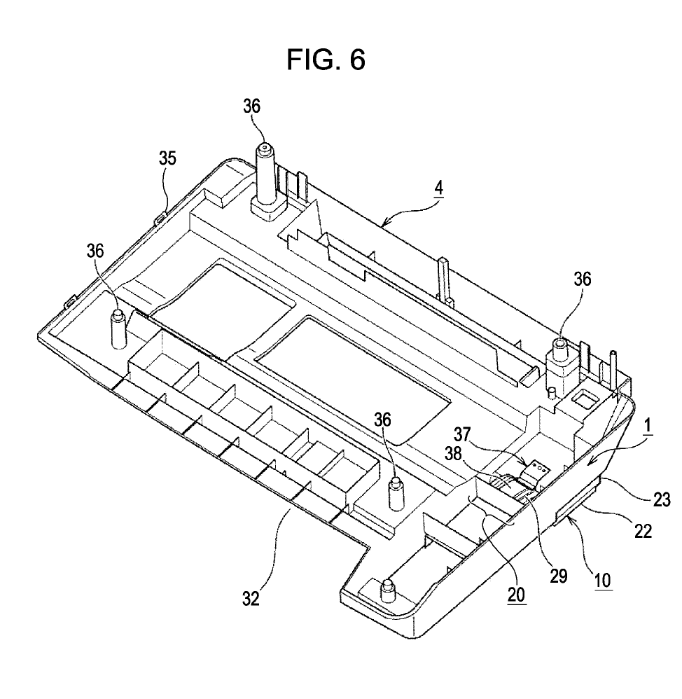

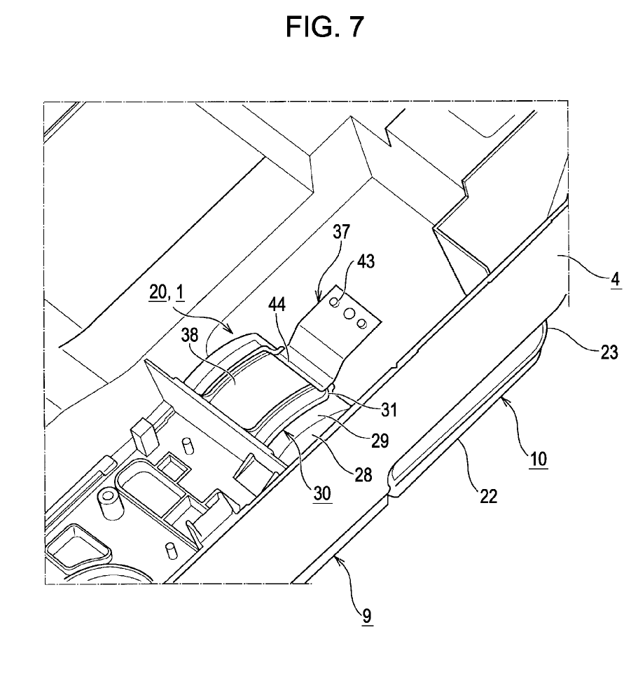

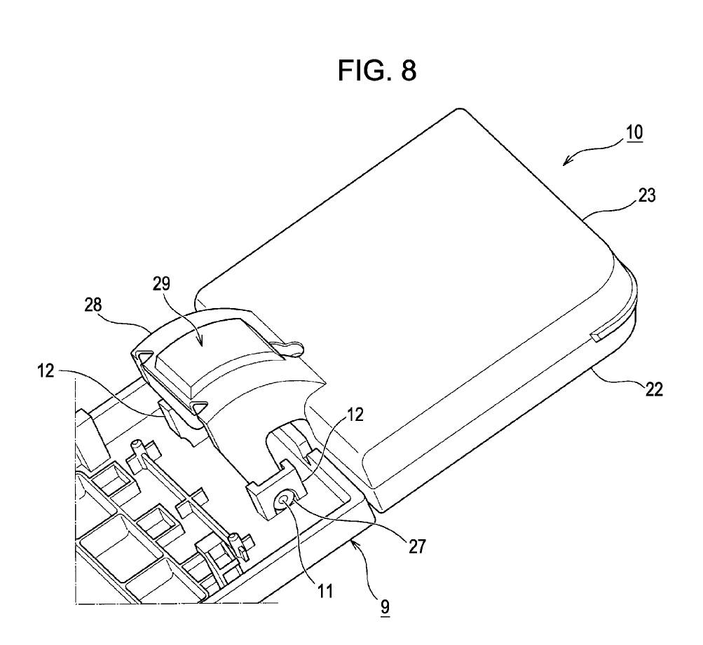

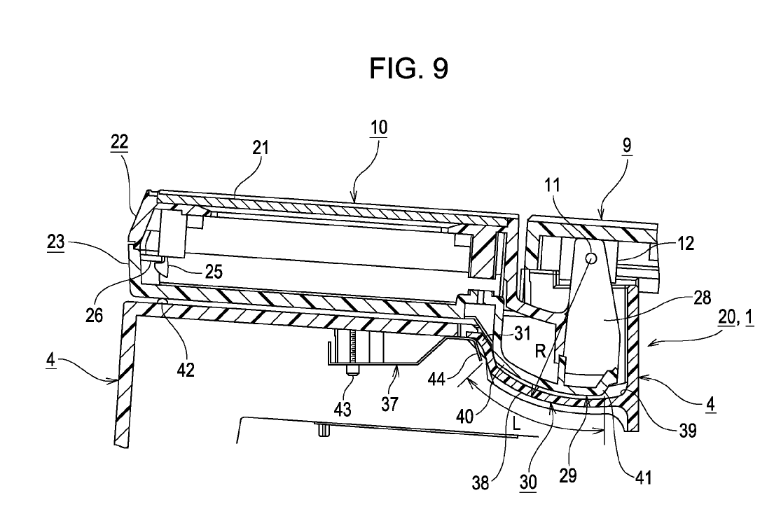

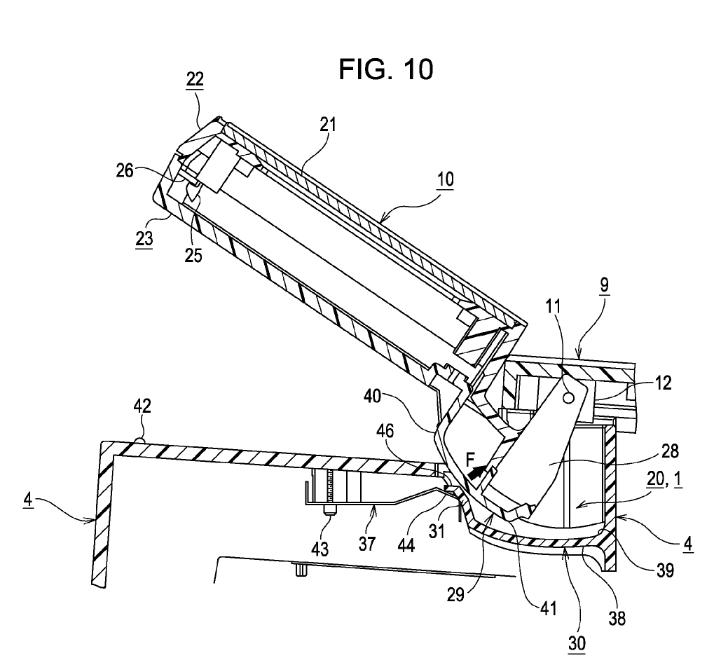

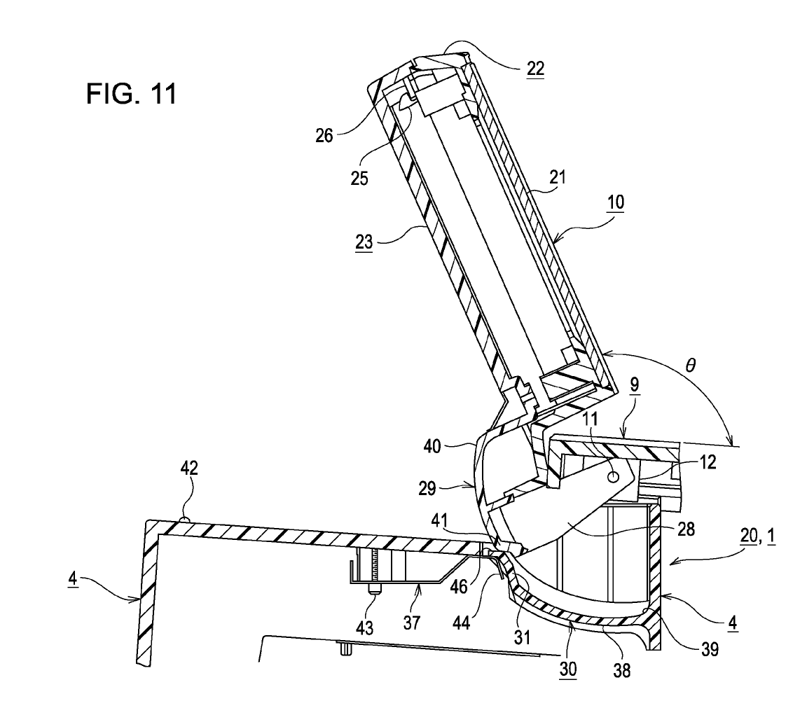

FIG. 2 is a perspective view of the body housing, the operation panel and the liquid crystal display of a printer provided with the tilt device according to the first embodiment in a state in which the upper cover is removed viewed obliquely from the right front and FIG. 3 is an exploded perspective view of a portion around a mounting portion of the operation panel and the liquid crystal display of the same printer in an enlarge scale. FIG. 4 is a perspective view of the liquid crystal display of the same printer in an enlarged scale. FIG. 5 is an exploded perspective view of the liquid crystal display of the same printer. FIG. 6 is a perspective view of the same printer in a state in which the body housing is inverted. FIG. 7 is a perspective view of the portion around the mounting portion of the operation panel and the liquid crystal display of the same printer in an enlarged scale. FIG. 8 is a perspective view showing a portion around the tilt device of the same printer viewed from the back side in an enlarged scale. FIG. 9 is a side cross section showing an operating state of the tilt device when the liquid crystal display of the same printer is in the folded posture position. FIG. 10 is a side cross section showing an operating state of the tilt device when the liquid crystal display of the same printer is in a position between the folded posture position and an upright posture position. FIG. 11 is a side cross section showing an operating state of the tilt device when the liquid crystal display of the same printer is in the upright posture position.

The tilt device 1 according to the first embodiment basically includes the liquid crystal display 10 as a tiling member, the body housing 4 and the operation panel 9 as supporting members, and a load applying portion 20 provided between the liquid crystal display 10 and the body housing 4.

As shown in FIG. 4 and FIG. 5, the liquid crystal display 10 includes a cover 21 formed of translucent material, an upper housing 22 to which the cover 21 is attached, a lower housing 23 mounted below the upper housing 22, and liquid crystal, not shown, arranged in an internal space between the upper housing 22 and the lower housing 23.

The upper housing 22 includes a window portion 24 for viewing the liquid crystal, and an adequate number of locking claws 25 for locking the same with the lower housing 23. The lower housing 23 includes locked portions 26 to be locked by the locking claws 25 of the upper housing 22, a shaft portion 27 which serves as the hinged end 11, and a curved arm portion 28 for connecting the body of the lower housing 23 and the shaft portion 27. The shaft portion 27 and the arm portion 28 are each formed into a size which is accommodated within the width of the body of the lower housing 23 for facilitating downsizing or reduction of the width of the printer body 3. The shaft portion 27 is tiltably supported by bearing portions 12 provided on the back side of the operation panel 9 as shown in FIG. 8.

As shown in FIG. 9, the peripheral surface of the arm portion 28 serves as a press-contact receiving portion 29 which is one of the components of the load applying portion 20, and is formed by an arcuate curved surface having a constant radius R about the hinged end 11 which is constituted by the shaft portion 27 for example. A length L of the press-contact receiving portion 29 in the circumferential direction is set to a length which does not receive a tilting load F indicated by an arrow in FIG. 10 from a press-contact applying portion 31 of a resilient strip 30, described later, in a state in which the liquid crystal display 10 is positioned at the folded posture position as the first posture position shown in FIG. 9 or at the upright posture position as the second posture position shown in FIG. 11. The length L of the press-contact receiving portion 29 in the circumferential direction and a position of the resilient strip 30, described later, where the press-contact applying portion 31 acts, are set with the relation with respect to a tilting angle θ of the liquid crystal display 10 taken into consideration.

The body housing 4 is a member which constitutes the upper housing of the printer body 3, and includes an upper cover mounting portion 32, a paper support mounting portion 33, and an operation panel mounting portion 34 on the front surface side as shown in FIG. 2 and FIG. 3. As shown in FIG. 6, an adequate number of locking claws 35 and the locking bosses 36 for mounting the body housing 4 to the lower housing of the printer body 3 are provided on the back surface side of the body housing 4. As shown in FIG. 3, FIG. 7, and FIG. 9, the resilient strip 30 as another one of the components of the load applying portion 20 is provided integrally with the body housing 4 at a proximal end of the tilting movement of the liquid crystal display 10 on the upper side of the operation panel mounting portion 34 of the body housing 4. In this embodiment, a separate auxiliary resilient strip 37 for reinforcing a resilient force of the resilient strip 30 is additionally provided on the back surface side of the body housing 4 near the resilient strip 30.

The load applying portion 20 is adapted to apply the tilting load F to the liquid crystal display 10 in a state in which the liquid crystal display 10 is positioned between the folded posture position and the upright posture position as shown in FIG. 10, and does not apply the tilting load F to the liquid crystal display 10 in the state in which the liquid crystal display 10 is at the folded posture position shown in FIG. 9 or at the upright posture position shown in FIG. 11. More specifically, the load applying portion 20 basically includes the resilient strip 30 provided on the body housing 4, the press-contact receiving portion 29 provided on the arm portion 28 at the proximal end of the titling movement of the liquid crystal display 10, and the press-contact applying portion 31 provided on part of the resilient strip, assuming a press-contact state with respect to the press-contact receiving portion 29 of the liquid crystal display 10 in a state in which the liquid crystal display 10 is positioned between the first posture and the second posture, and assuming a non-press-contact state with respect to the press-contact receiving portion 29 when the liquid crystal display 10 is positioned at the first posture position and the second posture position.

The resilient strip 30 includes a resiliency providing portion 38 extending forward from the portion of the body housing 4 described above and the press-contact applying portion 31 provided on a free end side of the resiliency providing portion 38. The resiliency providing portion 38 is formed of a tongue-shaped member having a resiliently deformable curved shape formed integrally with the body housing 4, and a storage section 39 for storing the press-contact receiving portion 29 of the liquid crystal display 10 in a state of being released and free from the tilting load F in the state in which the liquid crystal display 10 is at the folded posture position shown in FIG. 9 and the upright posture position shown in FIG. 11 is formed above the resiliency providing portion 38.

The press-contact applying portion 31 is adapted to come into press-contact with the press-contact receiving portion 29 of the liquid crystal display 10 in the state in which the liquid crystal display 10 is at the position between the folded posture position and the upright posture position as shown in FIG. 10, and be released from the press-contact state with respect to the press-contact receiving portion 29 of the liquid crystal display 10 in the state in which the liquid crystal display 10 is at the folded posture position shown in FIG. 9 or at the upright posture position shown in FIG. 11. More specifically, a portion of the resilient strip 30 at the free end thereof which is protruded toward the liquid crystal display 10 corresponds to the press-contact applying portion 31, so that the amount of displacement of the press-contact applying portion 31 is maximum when a front end 40 of the press-contact receiving portion 29 of the liquid crystal display 10 comes into contact with the press-contact applying portion 31 and when a rear end 41 of the press-contact receiving portion 29 of the liquid crystal display 10 comes into contact with the press-contact applying portion 31.

Therefore, the amount of resilient deformation of the resiliency providing portion 38 is maximized in the cases described above, so that an operator feels tactile feedback by a reaction force in association with a resilient deformation of the resiliency providing portion 38. More specifically, the operator feels the tactile feedback when the liquid crystal display 10 in the folded posture position shown in FIG. 9 starts to tilt toward an “intermediate position” shown in FIG. 10, when the liquid crystal display 10 at the upright posture position shown in FIG. 11 starts to tilt toward the “intermediate position” shown in FIG. 10, and when the liquid crystal display 10 at the “intermediate position” shown in FIG. 10 reaches the folded posture position shown in FIG. 9 or the upright posture position shown in FIG. 11, and is able to know the current posture of the liquid crystal display 10 sensuously.

As shown in FIG. 11, in the state in which the liquid crystal display 10 is at the upright posture position, the liquid crystal display 10 has a tendency to tilt in the direction to assume the folded posture shown in FIG. 9 by its own weight constitutionally. At this time, the weight of the liquid crystal display 10 is supported by the rear end 41 of the press-contact receiving portion 29 being seated on a seat portion (posture retaining portion) 46 near the distal end of the press-contact applying portion 31 of the resilient strip 30. In contrast, in the state in which the liquid crystal display 10 is at the folded posture position as shown in FIG. 9, the back surface of the lower housing 23 of the liquid crystal display 10 on the free end side of the tilting movement comes into contact with a projecting portion (another posture retaining portion) 42 provided on the front surface side of the body housing 4, so that the liquid crystal display 10 is supported horizontally with a slight gap kept with respect to the body housing 4.

In the first embodiment shown in the drawings, the auxiliary resilient strip 37 is provided for reinforcing the resilient force of the resilient strip 30 as described above (FIG. 6, FIG. 7, and FIG. 9). The auxiliary resilient strip 37 is formed of a leaf spring member which supports the resilient strip 30 from below for example. The auxiliary resilient strip 37 is attached to the back surface side of the body housing 4 above the position where the resilient strip 30 is provided with a mounting screw 43 as shown in the drawings. The free end of the auxiliary resilient strip 37 is bent and rather rounded at the distal end as shown in FIG. 9, and the bent portion serves as a rotatable support providing portion 44 which comes into contact with the lower surface of the press-contact applying portion 31 of the resilient strip 30 and rotatably supports the same from below.

Subsequently, the operating state of the tilt device 1 according to the first embodiment configured as described above will be described in three cases of when the liquid crystal display 10 is (1) at the folded posture position shown in FIG. 9, (2) at the intermediate position shown in FIG. 10, and (3) at the upright posture position shown in FIG. 11 separately.

(1) When the Liquid Crystal Display 10 is at the Folded Posture Position (See FIG. 9)

When the liquid crystal display 10 is at the folded posture position, the liquid crystal display 10 is supported horizontally by the hinged end 11 and the projecting portion 42, and is kept at the folded posture as shown in the drawing. At this time, the press-contact receiving portion 29 of the liquid crystal display 10 is stored completely in the storage section 39 above the resiliency providing portion 38, so that the tilting load F from the press-contact applying portion 31 does not act on the press-contact receiving portion 29 of the liquid crystal display 10.

(2) When the Liquid Crystal Display 10 is at the “Intermediate Position” (See FIG. 10)

When the liquid crystal display 10 is at the “intermediate position”, the liquid crystal display 10 is supported by the hinged end 11 and the press-contact applying portion 31 so as to be steplessly fixed to desired posture positions with a press-contact force from the press-contact applying portion 31. At this time, the tilting load F of a uniform magnitude is stably acts on the press-contact receiving portion 29 of the liquid crystal display 10.

(3) When the Liquid Crystal Display 10 is at the Upright Posture Position (See FIG. 11)

When the liquid crystal display 10 is moved fully upward, part of the upper housing 22 of the liquid crystal display 10 comes into contact with the upper end surface of the operation panel 9, so that the further tilting movement is restrained. In this state, the rear end 41 of the press-contact receiving portion 29 of the liquid crystal display 10 is apart from the press-contact applying portion 31 of the resilient strip 30, and is supported so as to be seated in the seat portion 46 as the posture retaining portion. Accordingly, the upright posture as shown in the drawing is maintained by the hinged end 11 and the seat portion 46. At this time, the press-contact receiving portion 29 of the liquid crystal display 10 is completely out from the storage section 39 above the resiliency providing portion 38, and the tilting load F from the press-contact applying portion 31 does not act on the press-contact receiving portion 29 of the liquid crystal display 10.

### SECOND EMBODIMENT

The tilt device 1 and the ink jet printer 100 to which the tilt device 1 is applied between the liquid crystal display 10 and the body housing 4 according to an aspect of the present invention are on the basis of the configuration as described thus far. However, modifications or omission of part of the configuration may be made without departing the scope of the present invention as a matter of course.

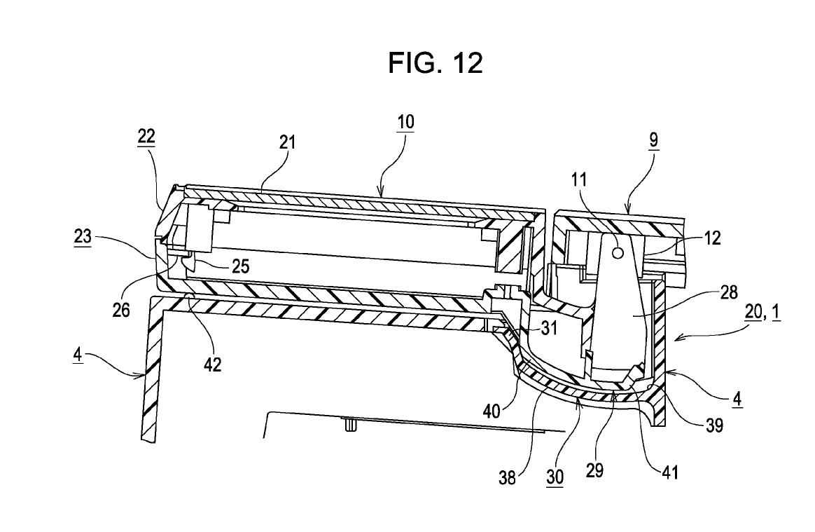

FIG. 12 shows a second embodiment in the present invention, and shows a side cross section showing an operating state of the tilt device when the liquid crystal display is at the folded posture position. According to the second embodiment, the auxiliary resilient strip 37 is not provided and the load applying portion 20 is configured of the resilient strip 30 and the press-contact receiving portion 29. The auxiliary resilient strip 37 may be omitted by securing the magnitude of the required tilting load F by the thickness of the resilient strip 30 or a rib. The same advantages and effects as in the first embodiment are achieved even when the tilt device 1 in this configuration is employed.

### THIRD EMBODIMENT

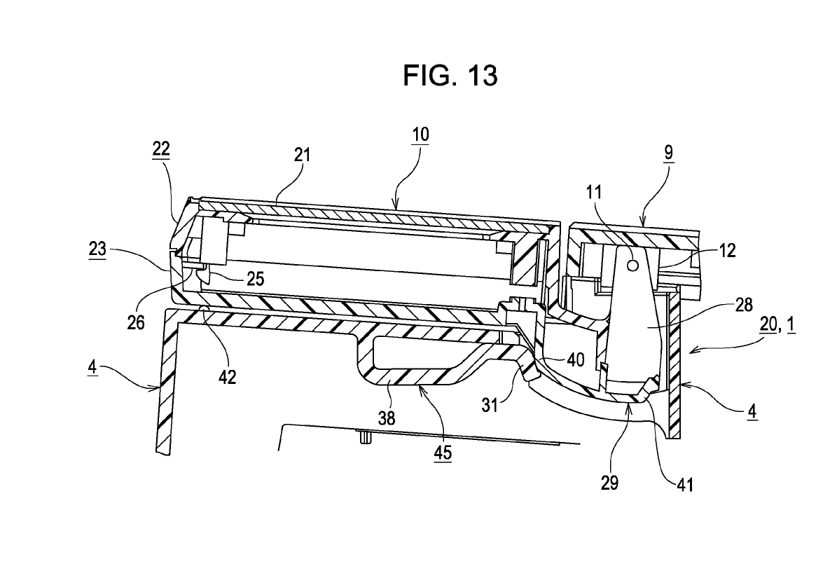

FIG. 13 shows a third embodiment in the present invention, and is a side cross section showing an operating state of the tilt device when the liquid crystal is at the folded posture position. In the third embodiment, the resilient strip 30 provided on the proximal end of the tilting movement of the liquid crystal display 10 is eliminated, and another resilient strip 45 which is integrally formed with the body housing 4 is provided at the position where the auxiliary resilient strip 37 is provided in the first embodiment.

In this configuration, the storage section 39 has an open structure, and is released from the manufacture tolerance, and the assembleability is improved. The same advantages and effects as in the first embodiment are achieved even when the tilt device 1 in this configuration is employed.

### OTHER EMBODIMENTS

The tilt device 1 and the printing apparatus 100 to which the tilt device 1 is applied between the liquid crystal display 10 and the body housing 4 according to the embodiments of the present invention basically have structures as described above. However, modifications or omission of part of the configuration may be made without departing the scope of the present invention as a matter of course.

The tilt device 1 according to the aspect of the present invention may be applied not only to the multipurpose middle-sized ink jet printer 100, and may be applied to a portable compact ink jet printer 100 or a large-sized ink jet printer 100 being capable of printing on a large-sized rolled paper.

The tilt device 1 according to the aspect of the present invention is also applicable to other printing apparatus such as line printers, laser printers, or copying machines, and also to various electronic apparatus other than the printing apparatus, such as telephone sets, facsimile machines, digital video cameras.

The first posture and the second posture assumed by the liquid crystal display 10 are not limited to the folded posture and the upright posture as in the embodiments, and may be selected from various postures. The direction of tilting movement of the liquid crystal display 10 is not limited to the vertical direction, but may be other directions such as the lateral direction. The tilting member is not limited to the liquid crystal display 10, and may be applied widely to various tilting members used for the similar purposes.

1. A tilt device comprising:
a tilting member being capable of tilting with respect to a hinged end and tilting and being displaced between a first posture and a second posture;
a supporting member that supports the tilting member in a tiltable state;
a load applying portion provided between the tilting member and the supporting member for applying a tilting load which allows the tilting member to tilt in a state in which the tilting member is positioned between the first posture and the second posture and allows the tilting member to standstill at a desired position in a state of being free from a tilting force, at least one of the first posture position and the second posture position being out of a range where the tilting load from the load applying portion does not reach; and
a posture retaining portion that retains the posture of the tilting member positioned out of the range that the load applying portion applies the tilting load.

2. The tilt device according to claim 1, wherein the load applying portion includes:
a resilient strip provided on the supporting member;
a press-contact receiving portion provided at a proximal end of a tilting movement of the tilting member;
a press-contact applying portion provided on part of the resilient strip, assuming a press-contact state with the press-contact receiving portion of the tilting member in a state in which the tilting member is positioned between the first posture and the second posture and assuming a non-press-contact state with respect to the press-contact receiving portion when the tilting member is positioned at least at one of the first posture position and the second posture position.

3. The tilt device according to claim 2, wherein the resilient strip is provided with a storage section at the other portion for storing the press-contact receiving portion of the tilting member in a state of being free from the tilting load when the tilting member is at the first posture position or the second posture position.

4. The tilt device according to claim 2 or 3, wherein the press-contact applying portion is provided at a free end of the resilient strip at a portion protruded toward the tilting member, and the press-contact applying portion is adapted to be displaced to the maximum when a front end of the press-contact receiving portion of the tilting member in the direction of the tilting movement comes into contact with the press-contact applying portion and when a rear end of the press-contact receiving portion of the tilting member in the direction of the tilting movement comes into contact with the press-contact applying portion.

5. The tilt device according to any one of claims 2 to 4, wherein the tilting member has a tendency to tilt toward the first posture position by the tilting member's own weight when being at the second posture position, and the posture retaining portion is provided at the free end of the resilient strip and includes a seat portion for allowing an end portion of the press-contact receiving portion of the tilting member to be seated thereon and supporting the tilting member's own weight.

6. The tilt device according to any one of claims 2 to 5, wherein the press-contact receiving portion of the tilting member is formed into an arcuate curved surface having a constant radius about a hinged end, and the length in the circumferential direction of the arcuate curved surface is set to a length which prevents the tilting member from receiving the tilting load from the resilient strip in the state in which the tilting member is positioned at the first posture position or the second posture position.

7. The tilt device according to any one of claims 1 to 6, wherein the resilient strip is a tongue-shaped member which is resiliently flexible and deformable and is formed integrally with the supporting member extending from a portion of the supporting member positioned on the side of the proximal end of the tilting movement of the tilting member.

8. The tilt device according to any one of claims 1 to 7, wherein the supporting member includes the resilient strip and an auxiliary resilient strip for supporting the resilient strip from below for reinforcing the resilient force of the resilient strip.

9. An electronic apparatus comprising:
a liquid crystal display for displaying various kinds of information;
a body housing for mounting the liquid crystal display; and
a tilt device applied between the liquid crystal display and the body housing for causing the liquid crystal display to tilt with respect to a hinged end to a first posture and a second posture and also to a position between the first posture and the second posture,
wherein the tilt device includes:
a load applying portion for providing a tilting load which allows the liquid crystal display to tilt in a state in which the liquid crystal display is positioned between the first posture and the second posture and allows the liquid crystal display to standstill at a desired posture position in a state of being free from a tilting force, at least one of the first posture position and the second posture position being out of a range where the tilting load from the load applying portion does not reach; and
a posture retaining portion that retains the posture of the liquid crystal display positioned out of the range that the load providing portion applies the tilting load. In this configuration, the same advantages and effects as described above are achieved in the electronic apparatus such as a printer having the tilt device.

10. The electronic apparatus according to claim 9, wherein the press-contact applying portion is provided at a free end of the resilient strip at a portion protruded toward the liquid crystal display, and the press-contact applying portion is adapted to be displaced to the maximum when a front end of the press-contact receiving portion of the liquid crystal display in the direction of the tilting movement comes into contact with the press-contact applying portion and when a rear end of the press-contact receiving portion of the liquid crystal display in the direction of the tilting movement comes into contact with the press-contact applying portion.
